(19) United States
(12) Patent Application Publication
(10) Pub. No.: US 2026/0106303 A1
(43) Pub. Date: Apr. 16, 2026

(54) BATTERY TRAY

(71) Applicant: SAMSUNG SDI CO., LTD., Yongin-si (KR)

(72) Inventor: Yeontae JEONG, Yongin-si (KR)

(21) Appl. No.: 19/206,928

(22) Filed: May 13, 2025

(30) Foreign Application Priority Data
Oct. 10, 2024 (KR) 10-2024-0137437

(51) Int. Cl. H01M 50/267; H01M 10/04; H01M 50/218; H01M 50/244; H01M 50/256

(52) U.S. Cl. CPC H01M 50/267; H01M 10/0427; H01M 50/218; H01M 50/244; H01M 50/256

(57) ABSTRACT

A battery tray includes a top plate, first inclined surfaces extending from the top plate downward to forming parts of openings, the first inclined surfaces being inclined such that diameters of the openings decrease in a downward direction in the parts of the openings, and second inclined surfaces extending from the first inclined surfaces downward and forming further parts of the openings, the second inclined surfaces being inclined such that the diameters of the openings decrease in the downward direction in the further parts of the openings. A plurality of side surfaces extend from the second inclined surfaces and forming a plurality of through holes that are connected to the openings formed by the first inclined surfaces and the second inclined surfaces.

### CROSS-REFERENCE TO RELATED APPLICATION

This application claims priority under 35 U.S.C. § 119 to Korean Patent Application No. 10-2024-0137437, filed in the Korean Intellectual Property Office on Oct. 10, 2024, the entire contents of which are hereby incorporated by reference.

### BACKGROUND

### Field

The present disclosure relates to a battery tray.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

With the technological development and demand for mobile devices, the demand for secondary batteries as an energy source is increasing. In particular, demand for cylindrical secondary batteries used in various mobile devices is increasing exponentially. Thus, the manufacture of cylindrical secondary batteries having various sizes are required for use in various mobile devices.

Secondary batteries are manufactured using a number of processes, and may be stored on trays when being transported to positioned where each process performed, or stored on trays in a standby state before transport. There may be increased manufacturing costs as new trays are required to store cylindrical secondary batteries of various sizes.

Various efforts have been made to manufacture trays that may accommodate different sized cylindrical secondary batteries.

The above information disclosed in this Background section is for enhancement of understanding of the background of the present disclosure, and therefore, it may contain information that does not constitute related (or prior) art.

### SUMMARY

The present disclosure solves the above-described technical problems, and aspects of the present disclosure provide a battery tray for solving the above-described technical problems.

These and other aspects and features of the present disclosure will be described in or will be apparent from the following description of embodiments of the present disclosure.

According to some embodiments of the present disclosure, there is provided a battery tray including a top plate, first inclined surfaces extending from the top plate downward to form parts of openings, the first inclined surfaces being inclined such that diameters of the openings decrease in a downward direction in the parts of the openings, second inclined surfaces extending from the first inclined surfaces, the second inclined surfaces being inclined such that the diameters of the openings decrease in the downward direction in the further parts of the openings, and a plurality of side surfaces extending from the second inclined surfaces and forming through holes that are connected to the openings formed by the first inclined surfaces and the second inclined surfaces.

According to some embodiments of the present disclosure, the battery tray may include a non-conductive material.

According to some embodiments of the present disclosure, the non-conductive material may include at least one of polypropylene, polystyrene, polyurethane, polyethylene, and polyimide.

According to some embodiments of the present disclosure, the top plate may be in a plane at a predetermined height from bottoms of the openings.

According to some embodiments of the present disclosure, inclinations of the first inclined surfaces with respect to a first plane that is parallel to the top plate may be greater than inclinations of the second inclined surface with respect to a second plane that is parallel to the top plate.

According to some embodiments of the present disclosure, the inclinations of the first inclined surfaces with respect to the first plane may be about 85° to about 89°.

The inclinations of the second inclined surfaces with respect to the second plane may be about 15° to about 35°.

According to some embodiments of the present disclosure, the through holes may be cylindrical in shape.

According to some embodiments of the present disclosure, diameters of the plurality of through holes may be about 3 mm to about 5 mm.

According to some embodiments of the present disclosure, a diameter of the openings at boundary lines between the first inclined surfaces and the second inclined surfaces may be about 16 mm to about 18 mm.

According to some embodiments of the present disclosure, the battery tray may further include a third inclined surface connected to an edge of the top plate and inclined outward from the top plate.

According to some embodiments of the present disclosure, the third inclined surface may be symmetric about a center of the top plate.

According to some embodiments of the present disclosure, an inclination of the third inclined surface with respect to a plane that is parallel to the top plate may be about 85° to about 89°.

According to some embodiments of the present disclosure, the openings in the battery tray are configured to contain coin-type battery cells or button-type battery cells.

According to some embodiments of the present disclosure, diameters of the battery cells are about 7 mm to about 17 mm.

According to some embodiments of the present disclosure, a total height of the battery tray may be about 10 mm to about 15 mm.

According to some embodiments of the present disclosure, diameters of the openings may be equal to each other, and wherein the diameters of the openings at tops of the first inclined surfaces may be about 17 mm to about 19 mm.

According to some embodiments of the present disclosure, centers of the openings may correspond to centers of the through holes.

According to some embodiments of the present disclosure, the openings may be formed at regular intervals in the top plate.

According to some embodiments of the present disclosure, the battery tray is configured such that the battery cells may be seated on the second inclined surfaces, and wherein an uppermost part of the battery cells may be positioned lower than the top plate.

According to some embodiments of the present disclosure, a battery tray capable of accommodating battery cells of various sizes may be provided.

According to some embodiments of the present disclosure, it is possible to provide a battery tray capable of preventing short circuits because the battery tray has a very high electrical resistance when accommodating battery cells.

According to some embodiments of the present disclosure, it is possible to reduce the cost of manufacturing new battery trays because a single battery tray may accommodate battery cells of various sizes.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a plan view of a battery tray according to an embodiment of the present disclosure.

FIG. 2 is a view of a cross-section of the battery tray of FIG. 1 taken along line X-X′.

FIG. 3 is a plan view showing an enlarged example of part A of FIG. 1.

FIG. 4 is a view of a cross-section of a battery tray according to an embodiment of the present disclosure.

FIG. 5 is a perspective view of a battery cell and a battery tray according to an embodiment of the present disclosure.

FIG. 6 is a perspective view of a coin-shaped battery cell according to an embodiment of the present disclosure.

FIG. 7 is a cross-sectional view of a coin-shaped battery cell according to an embodiment of the present disclosure.

FIG. 8 is a cross-sectional view of a battery tray with battery cells inserted therein according to an embodiment of the present disclosure.

FIG. 9 is a cross-sectional view of a battery tray with battery cells inserted therein according to another embodiment of the present disclosure.

FIG. 10 is a cross-sectional view of stacked battery trays with battery cells inserted therein according to an embodiment of the present disclosure.

FIG. 11 is a cross-sectional view of stacked battery trays with battery cells inserted therein according to another embodiment of the present disclosure.

FIG. 12 is a flowchart of a battery charging/discharging method according to an embodiment of the present disclosure.

FIG. 13 shows a process of contacting a probe to a battery cell during battery charging/discharging according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In this disclosure, the sizes and relative sizes of layers and regions illustrated in the drawings may be exaggerated for clarity of explanation. That is, the sizes shown in the drawings are only for convenience of understanding, and the embodiments are not limited to the sizes. Additionally, identical reference numerals refer to identical components throughout the specification.

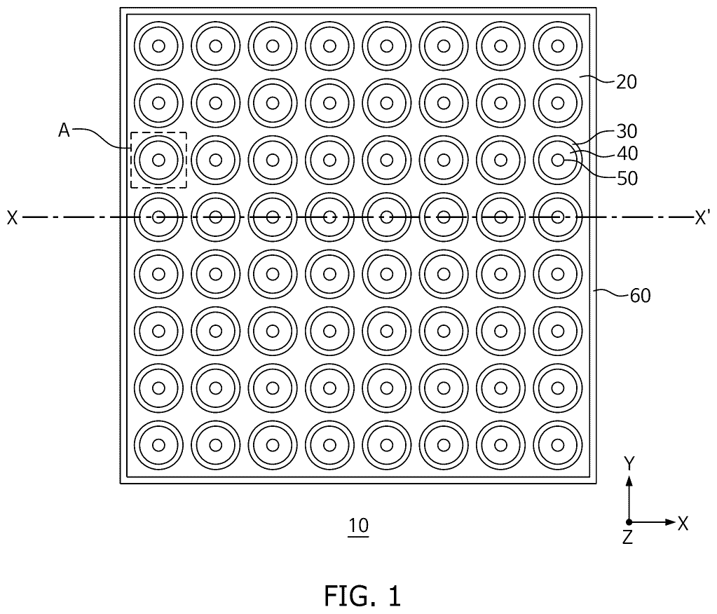

FIG. 1 is a plan view of a battery tray according to an embodiment of the present disclosure.

Referring to FIG. 1, a battery tray 10 may include a top plate 20, a plurality of first inclined surfaces 30, a plurality of second inclined surfaces 40, and a plurality of side surfaces 50. Here, the top plate 20, the plurality of first inclined surfaces 30, the plurality of second inclined surfaces 40, and the plurality of side surfaces 50 may be formed integrally. The battery tray 10 may further include a third inclined surface 60 connected to the edge of the top plate 20. The third inclined surface 60 may be formed integrally with the top plate 20.

A plurality of openings into which battery cells are inserted may be formed in the top plate 20. The plurality of openings may be formed in a circular shape. In the depicted embodiment, the diameters of the openings are the same, and the openings may be disposed to be spaced from each other at a constant interval. The battery cells inserted through the openings may be coin-type battery cells, button-type battery cells, etc. In some embodiments, the diameters of the battery cells may be larger than the heights of the battery cells.

In an embodiment, the arrangement of the plurality of openings may be set in based on the number of battery cells required in a battery manufacturing process. For example, in battery tray used in a packaging process during a battery manufacturing process, the openings may be arranged in an 8×8 matrix in the top plate 20, thereby forming a total of 64 openings. In another example, in a battery tray used in a battery charging/discharging process during a battery manufacturing process, the openings may be arranged in a 16×16 matrix form in the top plate 20, thereby forming a total of 256 openings. However, the matrix and number of the openings are not limited to these examples and may be formed with various arrangements and numbers.

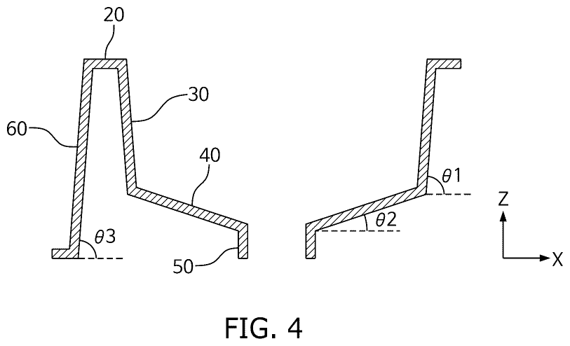

The top plate 20 may be in a plane at a predetermined height from the bottoms of the openings. The first inclined surfaces 30 are connected to the top plate 20 and may be inclined inward such that diameters of the openings decrease in the downward direction. The second inclined surfaces 40 are connected to the first inclined surfaces 30 and may be inclined inward such that the diameters of the opening further decrease in the downward direction. In some embodiments, the third inclined surface 60 may have an inclination outward from the sides of the tray. A more detailed description of the inclinations is provided below with reference to FIG. 4.

The plurality of side surfaces 50 are connected to the plurality of second inclined surfaces 40 and may form a plurality of through holes.

The third inclined surface 60 is connected to the edge of the top plate 20 and may be sloped outward. The third inclined surface 60 may be formed by being connecting to a part of the edge of the top plate 20 or may be formed by being connecting to the entire edge of the top plate 20. The third inclined surface 60 may be symmetric about the center of the top plate 20.

The battery tray 10 may be formed from a non-conductive material or be formed from a non-conductive material. Because a non-conductive material has a very high electrical resistance, the non-conductive material may impede the flow of current, and this property allows the battery tray 10 to act as an electrical insulator. Specifically, the electrical resistance of the non-conductive material may be set to 1×10⁴ Ω to 1×10⁹ Ω to thereby prevent short-circuiting of the battery cell. Therefore, the material of the battery tray 10 may be chosen based on the electrical resistance of the non-conductive material.

Given the non-conductive properties described above, the non-conductive material may include, for example, at least one of polypropylene (PP), polystyrene (PS), polyurethane (PU), polyethylene (PE), and polyimide (PI). Polypropylene, polystyrene, polyurethane, polyethylene, and polyimide are based on polymer substances and have very high electrical resistance, excellent electrical safety, and high flexibility and elastic resilience, which allow the materials to easily absorb shock.

Because of the characteristics of the material described above, the battery tray 10 may prevent short-circuiting of the battery cells due to the high electrical resistance of the battery tray 10 when in contact with the battery cells. In some embodiments, when battery cells are accommodated in the battery tray 10, the lower edges of each of the battery cells may come into contact with the second inclined surface 40 of the battery tray 10. Thus, the battery cells may be easily fixed by the elasticity and/or stretchability of the battery tray 10, and damage to the battery cells may be prevented or minimized during the process of transporting the battery cells.

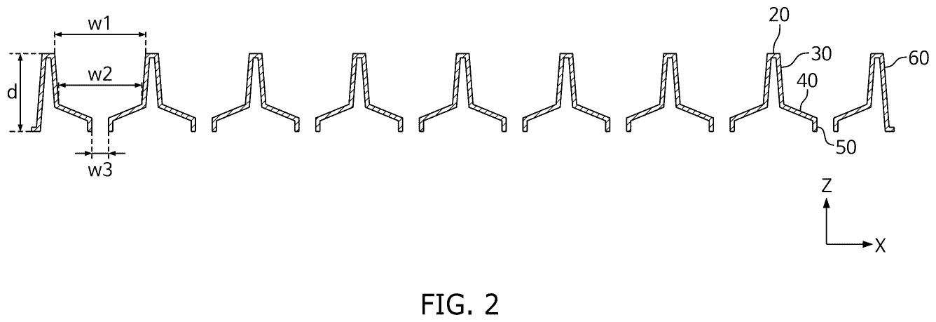

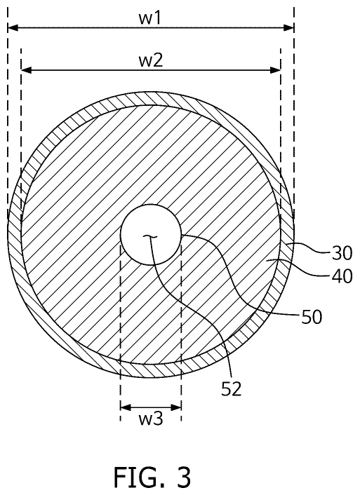

FIG. 2 shows an example of a cross-section of the battery tray of FIG. 1 taken along line X-X′, and FIG. 3 is a plan view showing an enlarged example of part A of FIG. 1.

Referring to FIGS. 2 and 3, a battery tray may include a top plate 20, a plurality of first inclined surfaces 30, a plurality of second inclined surfaces 40, a plurality of side surfaces 50, and a third inclined surface 60. A plurality of openings may be formed in the top plate 20, and the plurality of openings may be circular. In some embodiments, circles of different diameters may be formed by the plurality of first inclined surfaces 30, the plurality of second inclined surfaces 40, and the plurality of side surfaces 50.

The diameter w1 of the plurality of openings may be based on the diameters of the battery cells accommodated in the battery tray. Typically, the diameters of the battery cells accommodated in the battery tray may be from 7 mm to 17 mm. The diameter w1 of the plurality of openings needs to be formed larger than the diameters of the battery cells accommodated in the battery tray to accommodate the battery cells. In embodiments, the diameter w1 of the plurality of openings may be from 17 mm to 19 mm. This allows battery cells of different diameters to be accommodated in the battery tray regardless of the different diameters.

The diameter w2 of the circle at the boundary line between the first inclined surface 30 and the second inclined surface 40 may be based on the diameter of the battery cell seated on the second inclined surface 40. As described above, the diameter of the battery cell may be from 7 mm to 17 mm. Thus, according to some embodiments, the diameter w2 of the circle formed at the boundary line between the first inclined surface 30 and the second inclined surface 40 may be 16 mm to 18 mm. Because of this, battery cells of various diameters may be disposed on the second inclined surface 40 regardless of the variations in the diameters of the battery cells.

A plurality of through holes 52 may be formed by a plurality of side surfaces 50. The diameter w3 of the plurality of through holes 52 may be set based on the diameters of the battery cells and the diameter of the probes used for charging/discharging the battery. Specifically, the diameter w3 of the plurality of through holes 52 may be less than the diameters of the battery cells and greater than the diameter of the probes. Here, the probes may be a device used to supply current to the battery cells or measure voltage. The probes may have a diameter, for example, of about 3 mm. In such a configuration, the diameter w3 of the plurality of through holes 52 may be 3 mm to 5 mm. This prevents the battery cells from falling through the plurality of through holes 52 and allows the probes to be easily inserted through the plurality of through holes 52 to make accurate and stable contacts with the battery cells.

The total height d of the battery tray may be based on the heights of the battery cells accommodated in the battery tray. In an example, the heights of the battery cells may be less than their diameters. In an embodiment, the total height d of the battery tray may be from 10 mm to 15 mm. Because of this, the battery cells disposed on the second inclined surface 40 do not protrude beyond the upper plate, so the battery cells may be stably accommodated. However, the size of the battery tray in the present disclosure is not limited to the embodiments shown in FIGS. 2 and 3.

FIG. 4 is a view of an example of a cross-section of a battery tray according to an embodiment of the present disclosure.

Referring to FIG. 4, the battery tray may include a top plate 20, a first inclined surface 30, a second inclined surface 40, a side surface 50, and a third inclined surface 60. The first inclined surface 30 is connected to the top plate 20 and may have an inclination inward. The second inclined surface 40 is connected to the first inclined surface 30 and may have an inclination inward. The third inclined surface 60 is connected to the edge of the top plate 20 and may have an inclination outward. The top plate 20 may be in a plane at a predetermined height from the bottoms of the openings, and the inclination θ1 of the first inclined surface 30 with respect to a plane that is parallel to the top plate 20 may be greater than the inclination θ2 of the second inclined surface 40.

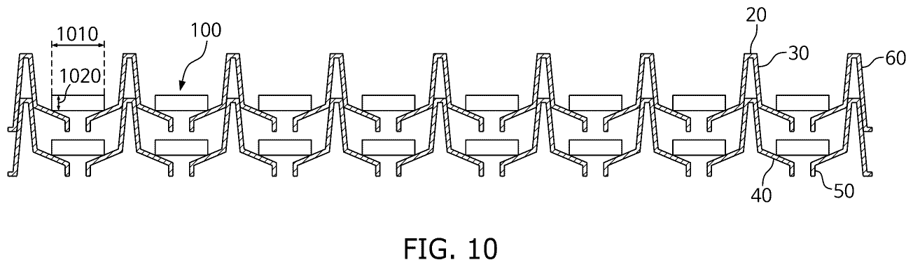

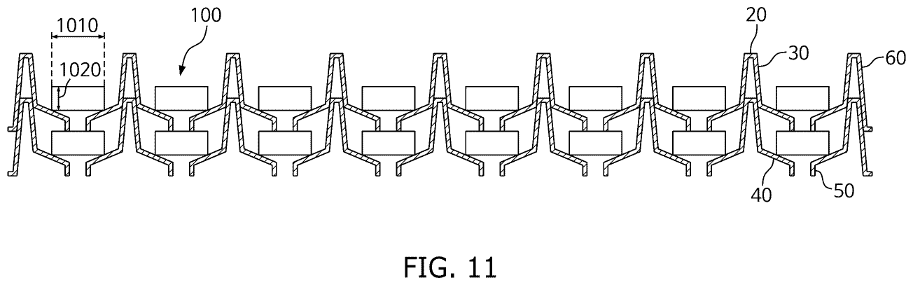

According to embodiments, the inclination θ1 of the first inclined surface 30 with respect to a plane parallel the top plate 20 may be 85° to 89°. This allows easy insertion of battery cells into the battery tray. Further, when stacking battery trays, the stacked battery trays may be stably fixed by the first inclined surface 30 and the third inclined surface 60. A more detailed description of the configuration is provided below with reference to FIGS. 10 and 11.

The inclination θ2 of the second inclined surface 40 with respect to a plane parallel to the top plate 20 may be 15° to 35°. Because of this, the battery cell may be disposed on the second inclined surface 40 regardless of the diameter of the battery cell. Due to the inclination of the second inclined surface 40, the battery cell may be easily aligned in the inner central portion of the space formed by the first inclined surface 30.

The inclination θ3 of the third inclined surface 60 with respect to a plane that is parallel to the top plate 20 may be 85° to 89° Thus, the battery tray may be easily secured by the third inclined surface 60 when disposed on the ground. The inclination of the side surface 50 with respect to a plane parallel to the top plate 20 may be 90°. That is, the side 50 may be perpendicular to the top plate 20. Accordingly, the side surface 50 may form a through hole having a constant diameter throughout the length of the through hole. In other embodiments, the side surface 50 may have a diameter that becomes wider in downward direction (i.e., a direction away from the top plate 20).

It should be noted that the inclination of each component of the battery tray according to the present disclosure is not limited by the embodiment shown in FIG. 4.

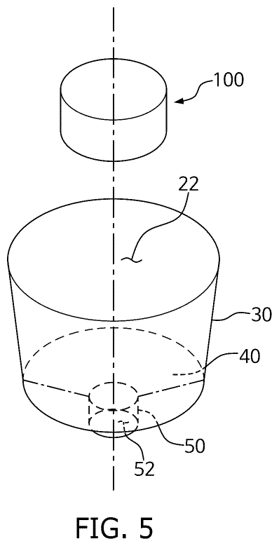

FIG. 5 is a perspective view of an example of a battery cell and a battery tray according to one embodiment of the present disclosure.

Referring to FIG. 5, a battery cell 100 may be accommodated in a battery tray 10. The battery cell 100 may include a case and an electrode assembly and an electrolyte solution accommodated in the case. The battery cell 100 may include an electrode assembly having a positive electrode, a negative electrode, and a separator positioned between the electrodes accommodated in a sealed a case together with an electrolyte solution, with the electrode assembly being laminated or wound. The electrode assembly and the electrolyte solution contained within the case may react electrochemically to generate energy.

The battery cells 100 accommodated in the battery tray 10 may include coin-type or button-type battery cells. The diameter of the battery cell 100 may be 7 mm to 17 mm. The height of the battery cell 100 may be 2.7 mm to 7.65 mm.

The diameters of the openings 22 may be larger than the diameters of the through holes 52. In the structure of the battery tray, the diameters openings 22 are larger than the diameters of the through holes 52, with the first inclined surface 30 and the second inclined surface 40 formed with diameters that are sized in the difference in diameters between the plurality of openings 22 and the plurality of through holes 52.

The centers of the plurality of openings 22 may correspond to the centers of the plurality of through holes 52. As shown in FIG. 5, the central axes of the plurality of openings 22 may coincide with the central axes of the plurality of through holes 52. Because of this, the probe may easily contact the electrode terminal located at the center of the battery cell 100 during the formation process.

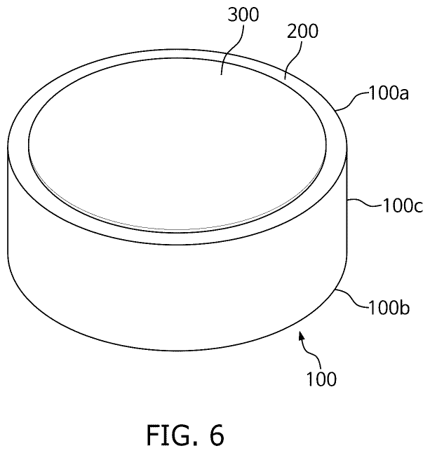

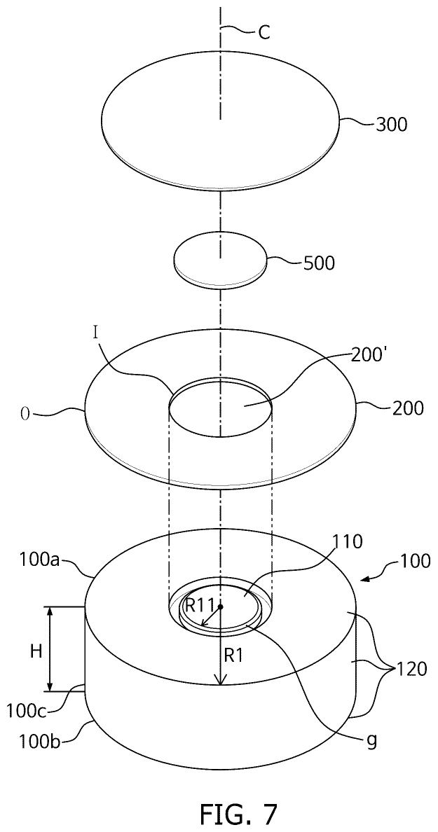

FIG. 6 is a perspective view showing an example of a coin-type battery cell according to an embodiment of the present disclosure, and FIG. 7 is an exploded perspective view showing an example of a coin-type battery cell according to an embodiment of the present disclosure.

As shown in FIGS. 6 and 7, a secondary battery 100 according to one or more embodiments is a micro-sized secondary battery and may be a coin cell or a button cell but is not limited thereto and may be a cylindrical or pin-type battery.

The coin cell or button cell is a battery in the form of a thin coin or button and may refer to a battery having a ratio of height to diameter (height/diameter) of 1 or less but is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

FIG. 6 is a perspective view of a battery according to an embodiment of the present disclosure. FIG. 7 is an exploded perspective view of the battery shown in FIG. 6. Referring to FIG. 7, the battery may include a battery cell 100 having first and second surfaces 100a and 100b opposite to each other and having first and second electrodes 110 and 120 respectively formed thereon (e.g., located thereon), a side surface 100c connecting (e.g., extending between) the first and second surfaces 100a and 100b, an insulating sheet 200 disposed on the first surface 100a of the battery cell 100 and having a conducting hole (e.g., a conducting opening) 200′ facing the first electrode 110 through which the first electrode 110 is exposed, and an electrode plate 300 disposed on the insulating sheet 200 and electrically connected to the first electrode 110 through the conductive hole 200′.

The battery cell 100 may have first and second surfaces 100a and 100b opposite to each other and a side surface 100c connecting (e.g., extending between) the first and second surfaces 100a and 100b. For example, the battery cell 100 according to one or more embodiments of the present disclosure may have circular first and second surfaces 100a and 100b and a side surface 100c forming a rounded circumferential surface (e.g., a cylindrical surface) connecting the circular first and second surfaces 100a and 100b to each other. For example, the battery cell 100 according to one or more embodiments of the present disclosure may be formed in the shape of a slimmed-down cylinder having a height H that is smaller than the diameter (i.e., twice the radius R1) of the first surface 100a. For example, with respect to the aspect ratio of the battery cell 100, the aspect ratio of the diameter of the first surface 100a to the height H may have a ratio in a range of about 5.4:12 to about 5.4:14.

The first and second electrodes 110 and 120, which have polarities opposite to each other, of the battery cell 100 may be respectively formed on (e.g., located on) the first and second surfaces 100a and 100b. For example, the first electrode 110 may be formed at (e.g., located at) the center of the first surface 100a, and the second electrode 120 may extend from the side surface 100c to a peripheral position surrounding the central position of the first surface 100a while being formed from (e.g., located at) the entire second surface 100b to the side surface 100c. The first and second electrodes 110 and 120 may be formed together at different locations on the first surface 100a. For example, the first electrode 110 may be formed at the center of the first surface 100a, and the second electrode 120 may be formed at a peripheral position (or a peripheral area or region) of the first surface 100a. The first and second electrodes 110 and 120 may be formed on the first surface 100a in a state of being electrically insulated from each other by being spaced from each other with an insulating gap g therebetween. Throughout this specification, when the first and second electrodes 110 and 120 are referred to as being formed on the first and second surfaces 100a and 100b of the battery cell 100, it may mean that the first and second electrodes 110 and 120 are formed at the respective center of the first and second surfaces 100a and 100b.

The insulating sheet 200 may be disposed on the first surface 100a of the battery cell 100. The conductive hole 200′ exposes at least a portion of the first electrode 110 formed on the first surface 100a and may be formed at the center of the insulating sheet 200. For example, the conducting hole 200′ may have a circular hole shape or may have a concentric circle shape having a centrifugal point C equal to that of the circular first surface 100a. In one or more embodiments of the present disclosure, the insulating sheet 200 may be made of a polymer resin material, for example, polyimide (PI).

The insulating sheet 200 may have (e.g., may be formed in) a shape surrounding (e.g., extending around a periphery of) the central conducting hole 200′ and may insulate the second electrode 120 and the first electrode 110 from each other by being between the second electrode 120 formed around the first surface 100a and the electrode plate 300 connected to the first electrode 110 through the conducting hole 200′. For example, the insulating sheet 200 may be interposed between the first surface 100a of the battery cell 100 and the electrode plate 300 and may insulate the second insulating sheet 200 formed around the first surface 100a of the battery cell 100 and the electrode plate 300 connected to the first electrode 110 from each other.

According to embodiments, the diameter of the battery cell 100 may be from 7 mm to 17 mm. That is, the radius R1 of the battery cell 100 may be 3.5 mm to 8.5 mm. The height H of the battery cell 100 may be 2.7 mm to 7.65 mm.

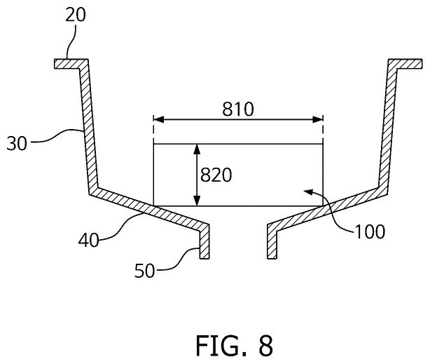

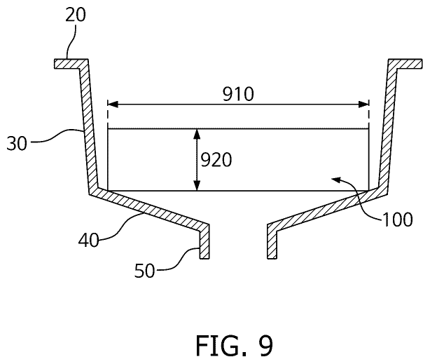

FIG. 8 is a cross-sectional view of an example of a battery tray with battery cells inserted therein according to one embodiment of the present disclosure, and FIG. 9 is a cross-sectional view showing an example of a battery tray with battery cells inserted therein according to another embodiment of the present disclosure.

Referring to FIGS. 8 and 9, battery cells 100 having different diameters may be accommodated in the battery tray. The diameters 810 and 910 of the battery cells 100 are less than the diameter of a circle formed by the boundary line between the first inclined surface 30 and the second inclined surface 40 and are greater than the diameter of the through hole. Accordingly, the battery cell 100 may be disposed on the second inclined surface 40.

According to embodiments, the diameter 810 of the battery cell 100 may be 7 mm to 12 mm. With such a configuration, the lower edge of the battery cell 100 is adjacent to the through hole and may be disposed on the second inclined surface 40.

The diameter 910 of the battery cell 100 may be 12 mm to 17 mm. With such a configuration, the lower edge of the battery cell 100 is adjacent to the first inclined surface 30 and may be disposed on the second inclined surface 40.

The heights 920 and 1020 of the battery cells 100 shown in FIGS. 8 and 9 may be the same. In another example, the heights 920 and 1020 of the illustrated battery cells 100 are different from each other. According to embodiments, the battery cells 100 are mounted on a plurality of second inclined surfaces 40, and the uppermost portions of the battery cells 100 are positioned lower than the top plate 20.

FIG. 10 is a cross-sectional view showing stacking of battery trays with battery cells inserted therein according to an embodiment of the present disclosure, and FIG. 11 is a cross-sectional view showing an example of stacking a battery tray with battery cells inserted therein according to another embodiment of the present disclosure.

Referring to FIGS. 10 and 11, the diameters 1010 and 1110 of the battery cells 100 are the same, and the heights 1020 and 1120 of the battery cells 100 may be different from each other. The height 1020 of the battery cell 100 may be short. As illustrated in FIG. 10, two battery trays containing short battery cells 100 may be stacked. In this configuration, the upper portions of the first inclined surfaces 30 and the upper portions of the third inclined surfaces 60 of the lower battery tray are in contact with the lower portions of the first inclined surfaces 30 and the lower portions of the third inclined surfaces 60 of the upper battery tray. This allows the battery trays to be stably stacked.

According to another embodiment, the height 1120 of the battery cell 100 may be tall. As illustrated in FIG. 11, two battery trays containing tall battery cells 100 may be stacked. At this time, the upper portion of the battery cell 100 of the lower battery tray disposed may be in contact with the of side surfaces 50 of the upper battery tray. This allows the battery trays to be stably stacked.

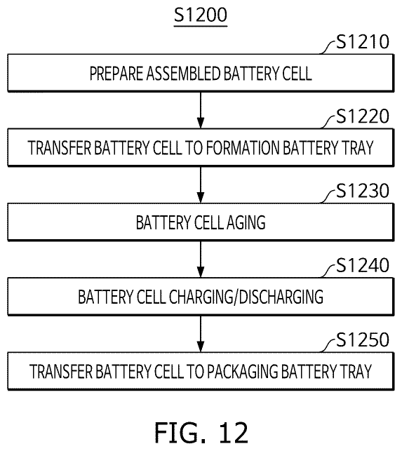

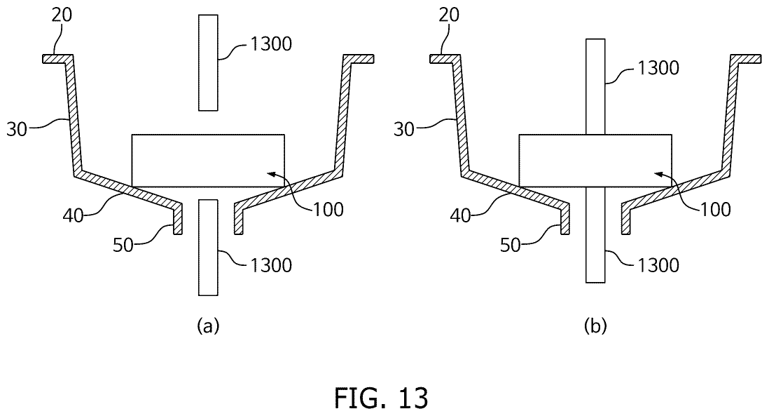

FIG. 12 is a flowchart of a battery charging/discharging method according to one embodiment of the present disclosure, and FIG. 13 illustrates a process of contacting a probe to a battery cell when charging/discharging a battery according to an embodiment of the present disclosure.

Referring to FIGS. 12 and 13, the battery charging/discharging method S1200 is initiated by preparing an assembled battery cells S1210. In one embodiment, a secondary battery 100 according to one or more embodiments is a micro-sized secondary battery and may be a coin cell or a button cell but is not limited thereto and may be a cylindrical or pin-type battery. The coin cell or button cell is a battery in the form of a thin coin or button and may refer to a battery having a ratio of height to diameter (height/diameter) of 1 or less but is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery). In one embodiment, the diameter of the battery cell 100 may be from 7 mm to 17 mm.

Next, the battery cells 100 is transferred to the formation battery tray S1220. A formation battery tray may be a device used for charging/discharging batteries. In embodiments, the battery tray may include a top plate 20, a plurality of first inclined surfaces 30, a plurality of second inclined surfaces 40, and a plurality of side surfaces 50, as described above. As also described above, the top plate 20, the plurality of first inclined surfaces 30, the plurality of second inclined surfaces 40 and the plurality of side surfaces 50 may be formed integrally. T the top plate 20 includes a plurality of openings into which battery cells 100 are inserted. The plurality of openings may be formed in a circular shape, with the diameters of the openings being the same, and the openings being spaced apart from each other at a constant interval. The arrangement of the openings may be set in consideration of the number of battery cells made in the battery manufacturing process. For example, in some embodiments of a battery tray used in a battery charging/discharging process during a battery manufacturing process, the openings are arranged in a 16×16 matrix form, thereby forming a total of 256 openings.

The material of the battery tray 10 may include or be formed of a non-conductive material. Because non-conductive materials have very high electrical resistance, the non-conductive materials may impede the flow of current, and this characteristic allows the battery tray 10 to act as an electrical insulator. Specifically, the electrical resistance of the non-conductive material may be 1×10⁴ Ω to 1×10⁹ Ω. In embodiments, the non-conductive material may include at least one of polypropylene, polystyrene, polyurethane, polyethylene, and polyimide. Thus, the battery tray may prevent short-circuiting of the battery cells due to the high electrical resistance of the battery tray in contact with the battery cells.

Thereafter, the battery cells 100 may be aged S1230.

Then, as shown in FIG. 13(a) and FIG. 13(b), each of the battery cells 100 may be charged and discharged (S1240). In embodiments, a plurality of through holes are formed in a plurality of side surfaces 50. The diameters of the through holes may be based the diameters of the battery cell 100 and the diameter(s) of the probe(s) 1300 used for battery charging/discharging. Specifically, the diameter of the plurality of through holes may be less than the diameters of the battery cells 100 and may be greater than the diameter of the probe 1300. Here, the probe 1300 is a device used to supply current to the battery cell 100 and/or measure the voltage of the battery cell 100. In an example, the diameter of the probe 1300 is about 3 mm, and the diameters of the through holes are 3 mm to 5 mm.

Referring to FIG. 13(a), a probe 1300 may be inserted through a an opening and a through holes to come in contact with electrode terminals of a battery cell 100. Referring to FIG. 13(b), each probe 1300 is connected to a positive terminal and a negative terminal of a battery cell 100 to charge/discharge the battery cell 100. At this time, the battery cell 100 may be separated from the second inclined surfaces 40 by the probe 1300.

Finally, the battery cells 100 may be transferred to the packaging battery tray S1250. In some embodiments of a battery tray used in a packaging process during a battery manufacturing process, the openings may be arranged in an 8×8 matrix form, thereby forming a total of 64 openings.

Although the present disclosure has been described above with respect to embodiments thereof, the present disclosure is not limited thereto. Various modifications and variations can be made thereto by those skilled in the art within the spirit of the present disclosure.

### DESCRIPTION OF REFERENCE SYMBOLS

10: battery tray
20: top plate
22: a plurality of openings
30: a plurality of first inclined surfaces
40: a plurality of second inclined surfaces
50: a plurality of side surfaces
52: a plurality of through holes
60: a third inclined surface
100: battery cell

1. A battery tray comprising:
a top plate;
first inclined surfaces extending from the top plate downward to form parts of openings, the first inclined surfaces being inclined such that diameters of the openings decrease in a downward direction in the parts of the openings;
second inclined surfaces extending from the first inclined surfaces downward and forming further parts of the openings, the second inclined surfaces being inclined such that the diameters of the openings decrease in the downward direction in the further parts of the openings; and
a plurality of side surfaces extending from the second inclined surfaces and forming through holes that are connected to the openings formed by the first inclined surfaces and the second inclined surfaces.

2. The battery tray as claimed in claim 1, wherein the battery tray comprises a non-conductive material.

3. The battery tray as claimed in claim 2, wherein the non-conductive material comprises at least one of polypropylene, polystyrene, polyurethane, polyethylene, and polyimide.

4. The battery tray as claimed in claim 1, wherein the top plate is in a plane at a predetermined height from bottoms of the openings.

5. The battery tray as claimed in claim 4, wherein inclinations of the first inclined surfaces with respect to a first plane that is parallel to the top plate are greater than inclinations of the second inclined surfaces with respect to a second plane that is parallel to the top plate.

6. The battery tray as claimed in claim 5, wherein the inclinations of the first inclined surfaces with respect to the first plane are about 85° to about 89°.

7. The battery tray as claimed in claim 5, wherein the inclinations of the second inclined surfaces with respect to the second planet are about 15° to about 35°.

8. The battery tray as claimed in claim 1, wherein the through holes are cylindrical in shape.

9. The battery tray as claimed in claim 8, wherein diameters of the through holes are about 3 mm to about 5 mm.

10. The secondary battery as claimed in claim 1, wherein diameters of the openings at boundary lines between the first inclined surfaces and the second inclined surfaces are about 16 mm to about 18 mm.

11. The battery tray as claimed in claim 4, further comprising a third inclined surface connected to an edge of the top plate and being inclined outward from the top plate.

12. The battery tray as claimed in claim 11, wherein the third inclined surface is symmetric about a center of the top plate.

13. The battery tray as claimed in claim 11, wherein an inclination of the third inclined surface with respect to a plane that is parallel to the top plate is about 85° to about 89°.

14. The battery tray as claimed in claim 1, wherein the openings in the battery tray are configured to contain coin-type battery cells or button-type battery cells.

15. The battery tray as claimed in claim 14, wherein diameters of the battery cells are about 7 mm to about 17 mm.

16. The battery tray as claimed in claim 1, wherein a total height of the battery tray is about 10 mm to about 15 mm.

17. The battery tray as claimed in claim 1, wherein diameters of the openings are equal to each other, and
wherein the diameters of the first parts of openings at tops of the first inclined surfaces are about 17 mm to about 19 mm.

18. The battery tray as claimed in claim 1, wherein centers of the openings correspond to centers of the through holes.

19. The battery tray as claimed in claim 1, wherein the are formed at regular intervals in the top plate.

20. The battery tray as claimed in claim 4, wherein the battery tray is configured such that the battery cells are seated on the second inclined surfaces, and such that an uppermost part of the battery cells is positioned lower than the top plate.
